(19) United States
(12) Patent Application Publication
(10) Pub. No.: US 2021/0272044 A1
(43) Pub. Date: Sep. 2, 2021

(54) SYSTEMS AND METHODS FOR JOB APPLICATION AND SELF-CHECK IN

(71) Applicant: Coupang Corp., Seoul (KR)

(72) Inventors: Yulhee LEE, Seoul (KR); MoonJung JANG, Seoul (KR); HyeLeen CHOI, Seoul (KR); Dukwon NAM, Seoul (KR)

(21) Appl. No.: 16/805,692

(22) Filed: Feb. 28, 2020

(51) Int. Cl. G06Q 10/06; G06Q 10/08; G06K 7/14

(52) U.S. Cl. CPC G06Q 10/063112; G06K 7/1417; G06Q 10/083

(57) ABSTRACT

Systems and methods of task acceptance are disclosed. One aspect of the present disclosure is directed to a mobile device. The mobile device comprises a display device, a scanning device, a memory storing instructions, and at least one processor configured to execute the instructions to receive a list of delivery tasks, the list of delivery tasks based on a stored set of preferences, display the list of delivery tasks, and receive, on the display device, an interaction with a user interface element to accept a delivery task; forward a task identifier associated with the accepted task to the server and receive a message in response including a code associated with a first delivery site for accomplishing the accepted delivery task; receive an interaction to confirm presence at the first delivery site; scan an indicia associated with the first delivery site, and determine whether the indicia matches the received code; and provide an indication that the accepted delivery task is performed at the first delivery site.

### TECHNICAL FIELD

The present disclosure generally relates to computerized systems and methods for automated mobile job requisition, distribution, and confirmation. In particular, embodiments of the present disclosure relate to inventive and unconventional systems and methods to enable independent, part-time, flexible, temporary, or other independent workers to select available delivery jobs using mobile devices and confirm the details of those jobs.

### BACKGROUND

Independent, flex, or occasional delivery workers spend a lot of time attempting to find delivery tasks suitable with their schedules and desired delivery areas. Current electronic systems for self-scheduling are inconvenient for these purposes, as the only tasks provided for selection may be those that lead a delivery worker to spend time making deliveries that are outside of their desired delivery area or available time to make deliveries.

In practice, electronically offering desirable delivery tasks to such delivery workers is difficult. Current electronic systems rely upon a multitude of systems to determine availability for distributing those tasks—including social networking services, chat services, online fillable forms, and informal communication (such as email, text messaging). These create technical boundaries for distributing work because receiving data from multiple sources can be difficult, if not impossible, to reconcile. Moreover, if a delivery worker accepts a delivery task through one channel substantially simultaneously as a second delivery worker accepts the same task through a different channel, one worker may walk away disappointed and be dissuaded from accepting further tasks.

Many times the delivery workers will receive undesirable routes and packages they cannot deliver conveniently. Moreover, current electronic systems are inflexible in terms of satisfying delivery workers' requests for convenient delivery tasks. These disadvantages, moreover, cause delayed deliveries and inefficient travel.

Other problems occur after the delivery workers accept a task. For example, the delivery worker may receive information indicating where to begin the task (e.g., a warehouse, distribution center, or other site). Being independent and occasional, the worker may not know the exact address for beginning the delivery tasks. While the worker's mobile device may indicate where to begin the delivery task, the worker may not know the exact location and may waste time going to the wrong place.

Further still, the sheer number of delivery tasks that some workers may have to complete can complicate user interfaces to the point where they are not useful for determining a next task. For example, if a delivery worker has accepted multiple tasks at the same camp, traditional user interfaces are unable to depict when a worker should—or should not—return to the same camp in a timely and helpful fashion. Such problems relating to camp attendance slow down delivery and cause technical inconveniences for the delivery workers (who must carefully review all information on their mobile devices) and delivery site workers (who must determine whether the delivery workers are at the delivery site at the right time).

Therefore, there is a need for improved methods and systems for self-assignment of flexible delivery work and confirmation of correct presence.

### SUMMARY

One aspect of the present disclosure is directed to a computer-implemented system for task acceptance, implemented on a mobile device. The mobile device comprises a display device, a scanning device, a memory storing instructions, and at least one processor. The at least one processor may be configured to execute the instructions to receive, from a server, a list of delivery tasks, the list of delivery tasks based on a stored set of preferences, display, on the display device, the list of delivery tasks, and receive, on the display device, an interaction with a user interface element to accept a delivery task. The at least one processor may be further configured to forward a task identifier associated with the accepted task to the server and receive a message in response including a code associated with a first delivery site for accomplishing the accepted delivery task; receive, on the display device, an interaction to confirm presence at the first delivery site; scan, via the scanning device, an indicia associated with the first delivery site, and determine whether the indicia matches the received code; and responsive to a determination that the indicia matches the received code, provide an indication that the accepted delivery task is performed at the first delivery site.

Another aspect of the present disclosure is directed to a computer system for task acceptance, comprising a memory storing instructions and at least one processor. The at least one processor may be configured to execute the instructions to receive and store a list of delivery tasks for acceptance, each delivery task associated with a delivery site; receive, from a mobile device, a request for one or more delivery tasks for a delivery worker; determine a set of stored delivery tasks for sending to the mobile device, and forward the set to the mobile device; receive, from the mobile device, an acceptance of a task for the delivery worker from the set of delivery tasks; determine whether to approve the received acceptance; and responsive to determining to approve the received acceptance, forward an approval message to the mobile device, the approval message including a code associated with the delivery site.

Yet another aspect of the present disclosure is directed to a computer-implemented system comprising the above-described mobile device and computer system.

Methods and computer-readable media implementing, complementing, or operating the above-described systems are also discussed herein. Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a block diagram of a system depicting a network of systems and devices for satisfying requisitions of delivery tasks from mobile devices, consistent with the disclosed embodiments.

FIG. 4A depicts exemplary user interfaces for use by a delivery worker to request particular types of delivery tasks on a mobile device, consistent with the disclosed embodiments.

FIG. 4B depicts exemplary user interfaces for use by a delivery worker to accept particular delivery tasks on a mobile device, consistent with the disclosed embodiments.

FIG. 5A depicts an exemplary method enabling configuration of preferences and job acceptance on a mobile device, consistent with the disclosed embodiments.

FIG. 5B depicts an exemplary method for presence confirmation on a mobile device, consistent with the disclosed embodiments.

FIG. 5C depicts exemplary user interfaces for presence confirmation on a mobile device, consistent with the disclosed embodiments.

FIG. 6A depicts an exemplary data structure for instantiating delivery tasks for distribution to delivery workers on a mobile device, consistent with the disclosed embodiments.

FIG. 6B depicts an exemplary user interface for data entry relating to a delivery task for distribution to delivery workers on a mobile device, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for distributing available delivery tasks to delivery workers based on individual delivery workers' preferences. Delivery workers may select particular areas of a city for delivery, and may be offered a series of tasks to deliver packages to those areas in exchange for payment (e.g., payment per package delivered or picked up from a customer). Delivery workers may request particular times of day for particular tasks as well. For example, a delivery worker may request to deliver overnight deliveries between the hours of 11:00 pm and 4:00 am, which may reduce the number of delivery tasks available to that delivery worker. (Embodiments of the present disclosure may include a user interface that allows for manual override of delivery workers' preferences.) Delivery workers may request a particular type of task, including delivery (e.g., taking a package from a delivery site such as a camp and leaving it at a customer's residence), return (e.g., taking a package from a customer's residence and returning it to the delivery site or a return center), and delivery/return (e.g., taking one package from a camp to a customer's residence, and taking a second package from a nearby residence to the camp). Delivery workers may use a mobile device to confirm that they have arrived at the correct delivery site at the correct time.

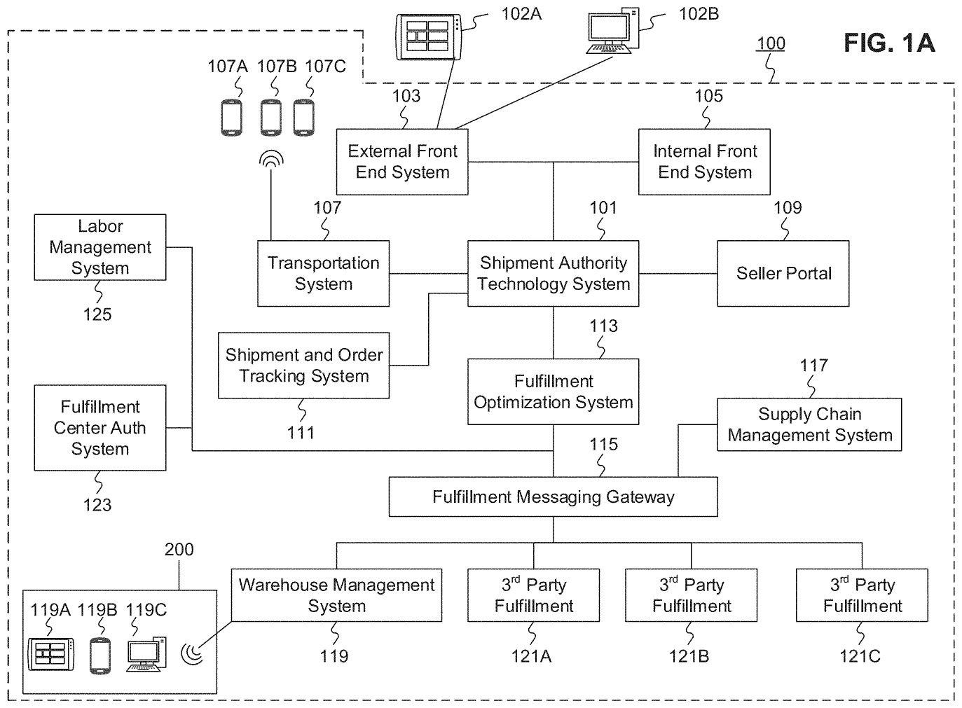

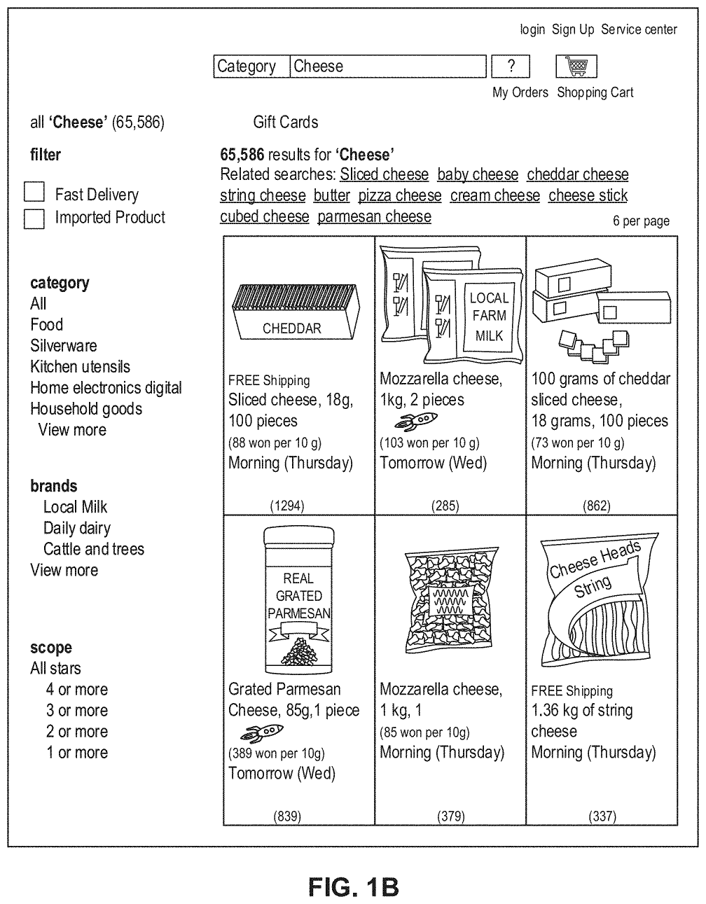

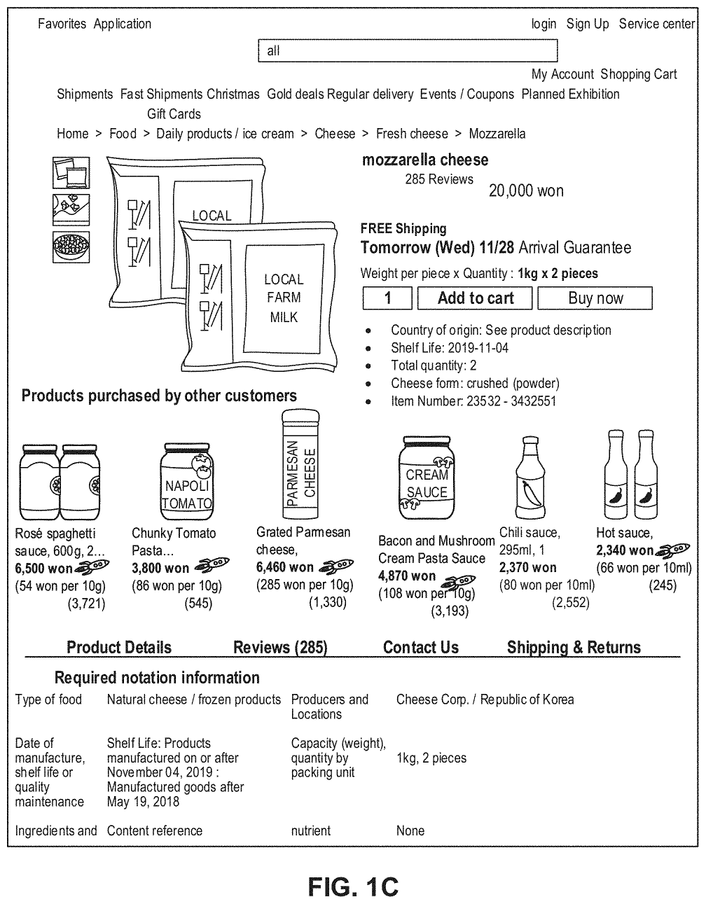

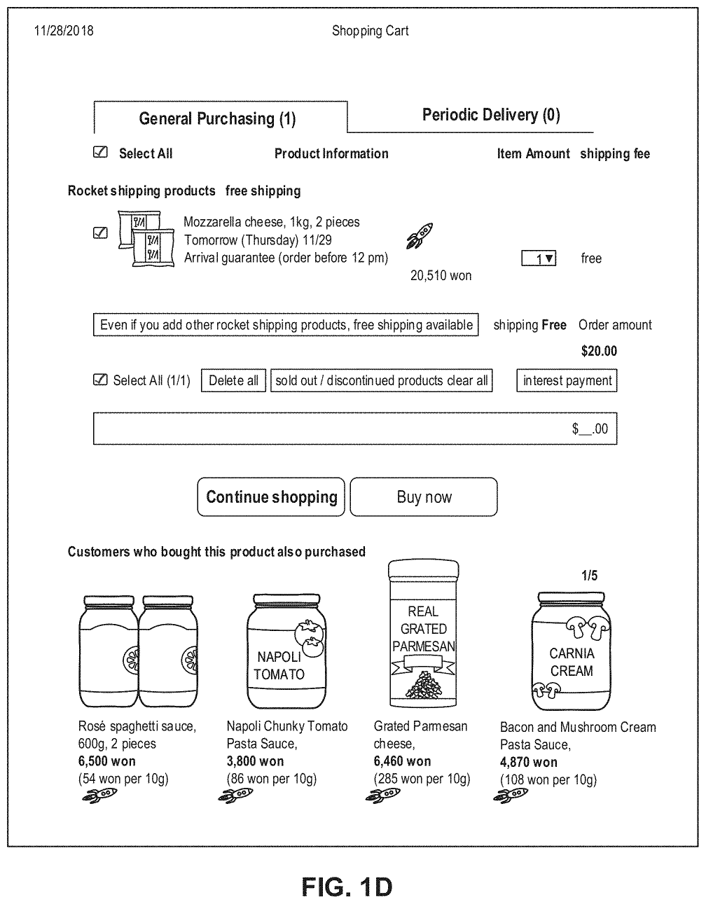

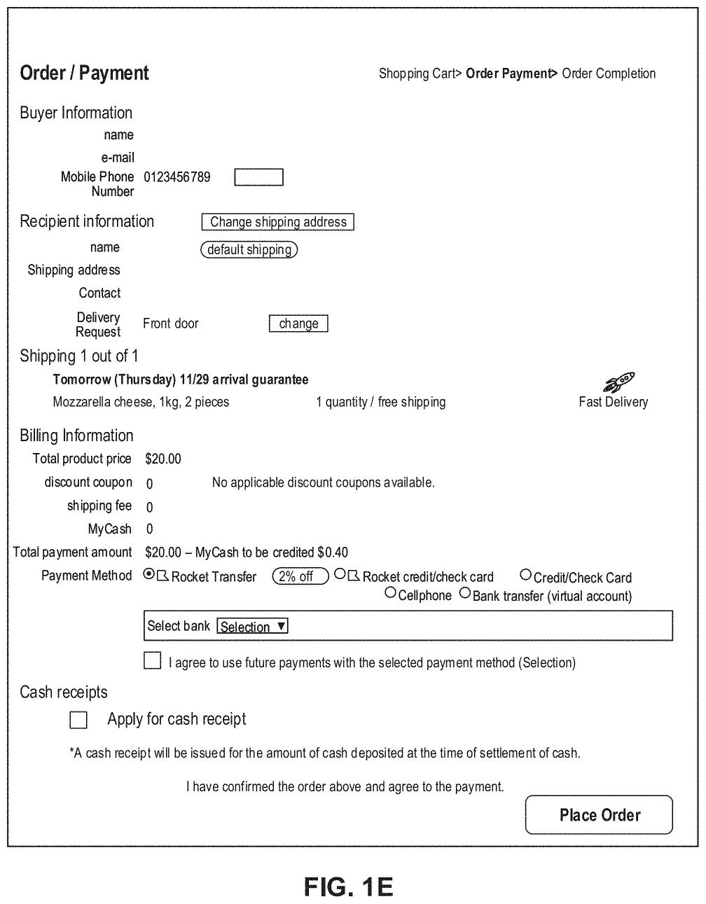

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 1078, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

A set of graphical user interfaces, shown in FIGS. 1B, 1C, 1D, and 1E, illustrate some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device, such as mobile devices 107A-107C. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

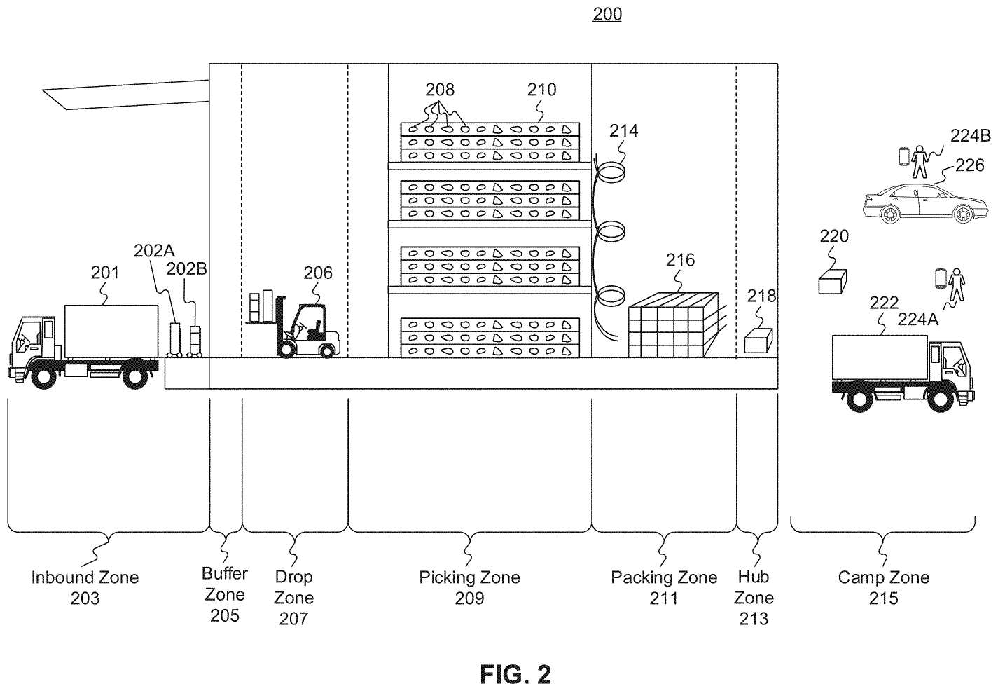

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1196, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (sometimes referred to as a “rebin worker”) will receive item 208 from picking zone 209 and determine the order to which it corresponds. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

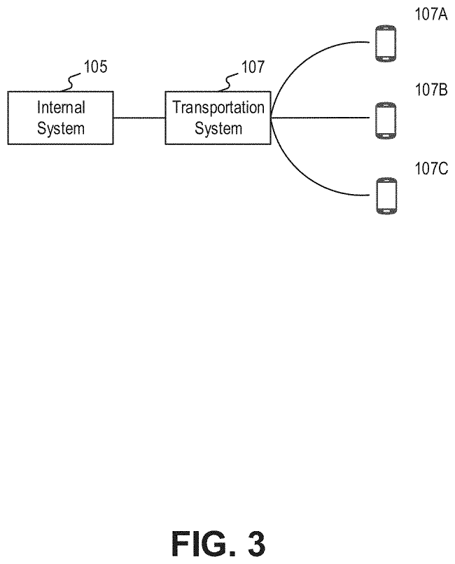

FIG. 3 is a block diagram of a system 300 depicting a network of systems and devices for satisfying requisitions of delivery tasks from mobile devices, consistent with the disclosed embodiments. System 300 includes internal front end system 105, transportation system 107, and mobile devices 107A-107C

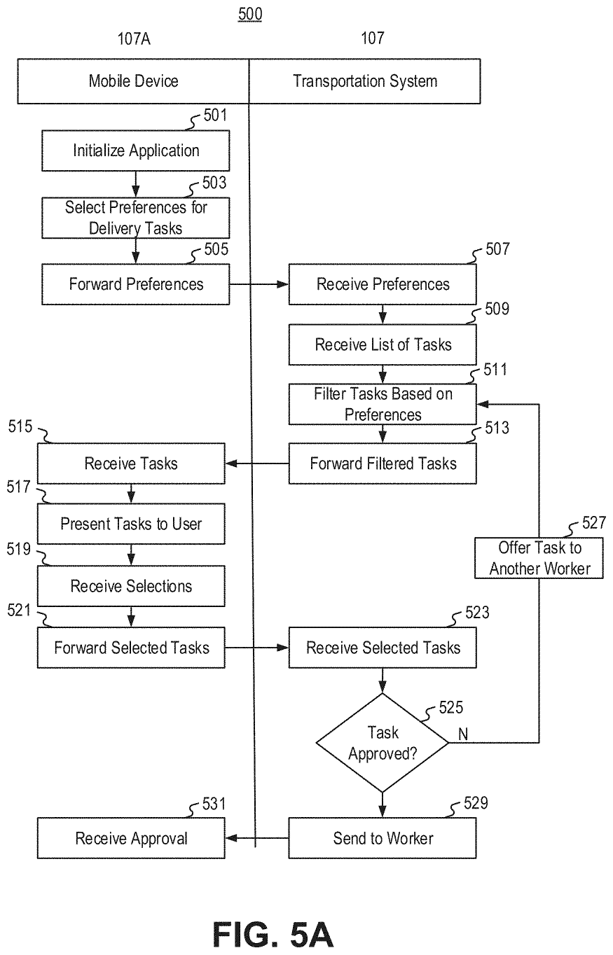

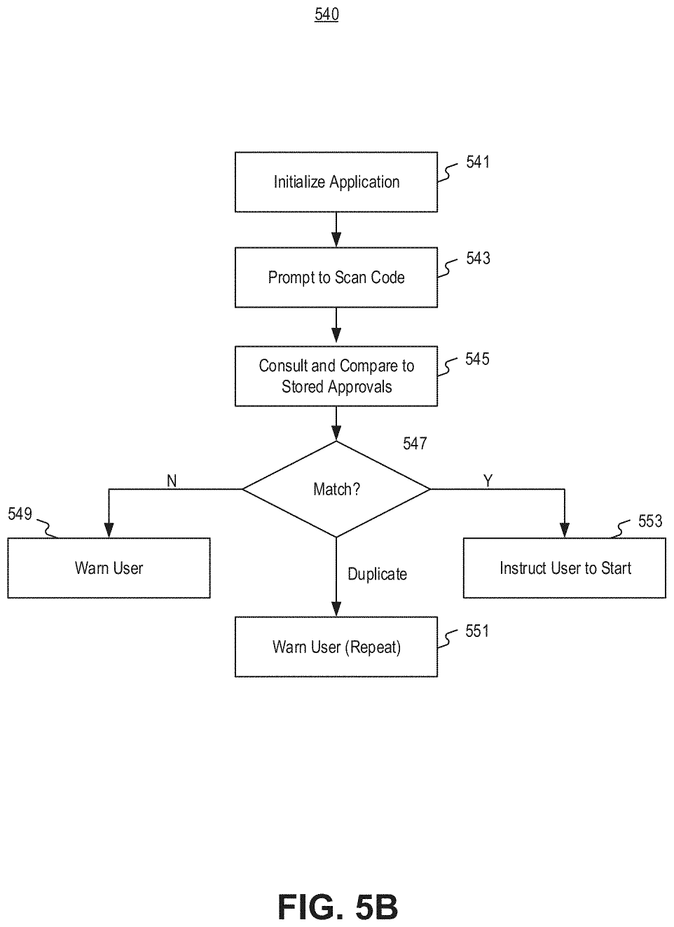

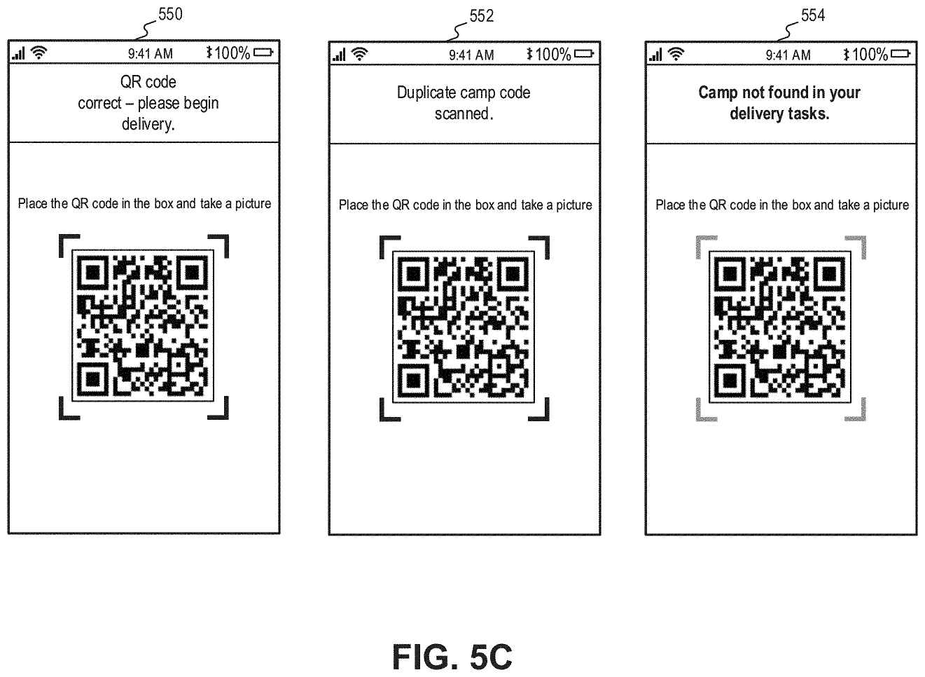

Internal front end system 105, as described above, may be implemented as a computer system that enables internal users (e.g., an administrator of camp zone 215, a packing worker working in packing zone 211, a worker who works at packing zone 211 or camp zone 215, or the like) to interact with one or more systems in system 100. For example, as described below with respect to FIG. 5A, an administrator of camp zone 215 may receive a request from a delivery worker (e.g., using mobile device 107A) to accept a particular job. The administrator may use internal front end system 105 (e.g., using a computer, mobile device, or other electronic system) to decline or approve the request.

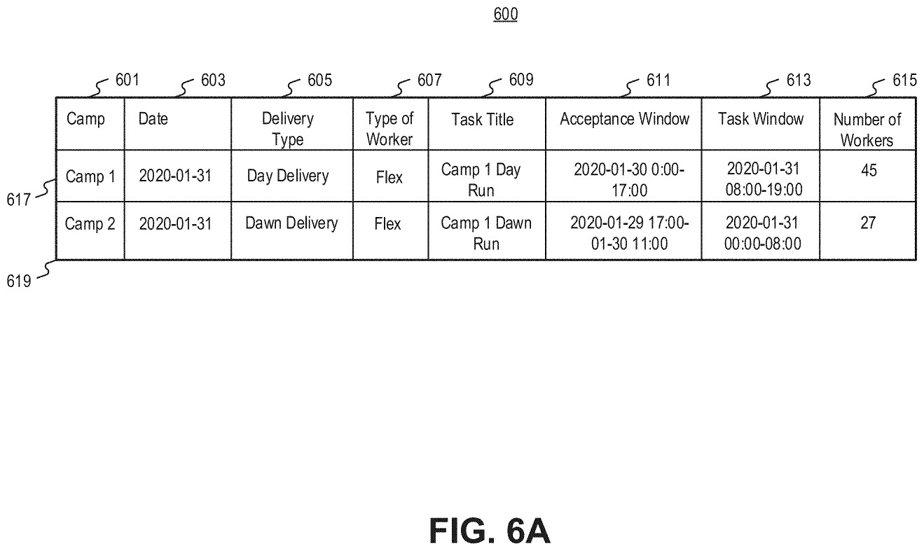

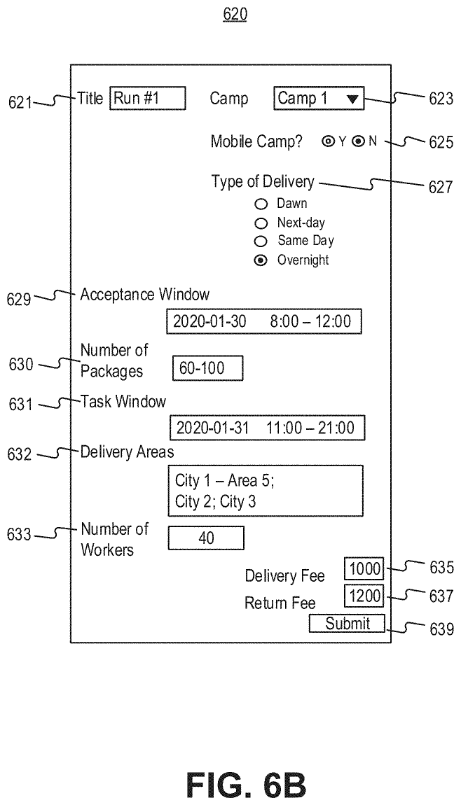

As another example, an administrator of camp zone 215 may utilize a system (e.g., a mobile device) to access a user interface stored on and operated by internal front end system 105 to store, modify, create, or delete delivery tasks. For example, as described below with respect to FIGS. 6A and 6B, an administrator may use internal front end system 105 (e.g., using a computer, mobile device, or other electronic system) to enter data concerning a delivery task or upload a data structure comprising a plurality of delivery tasks.

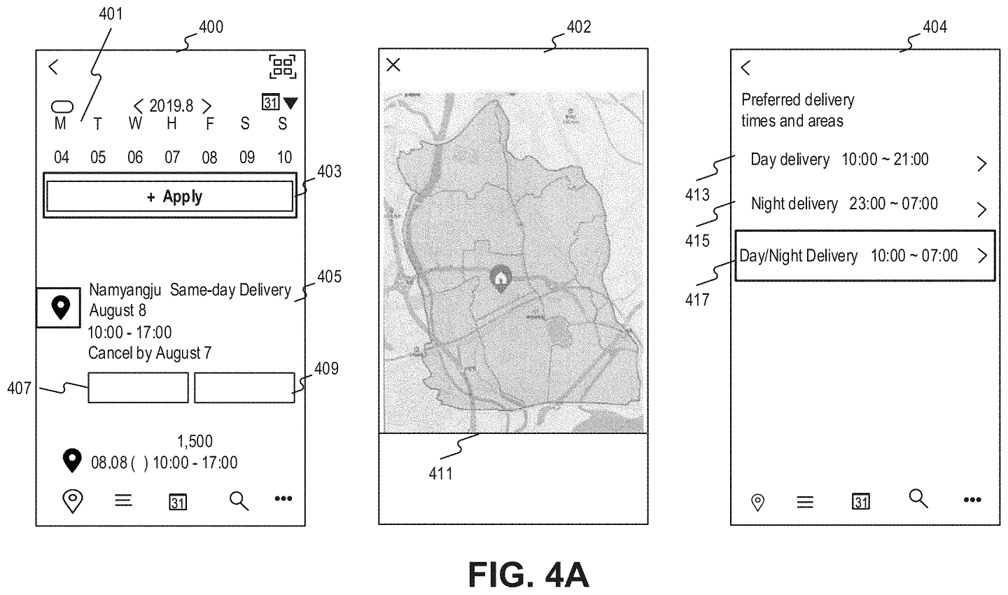

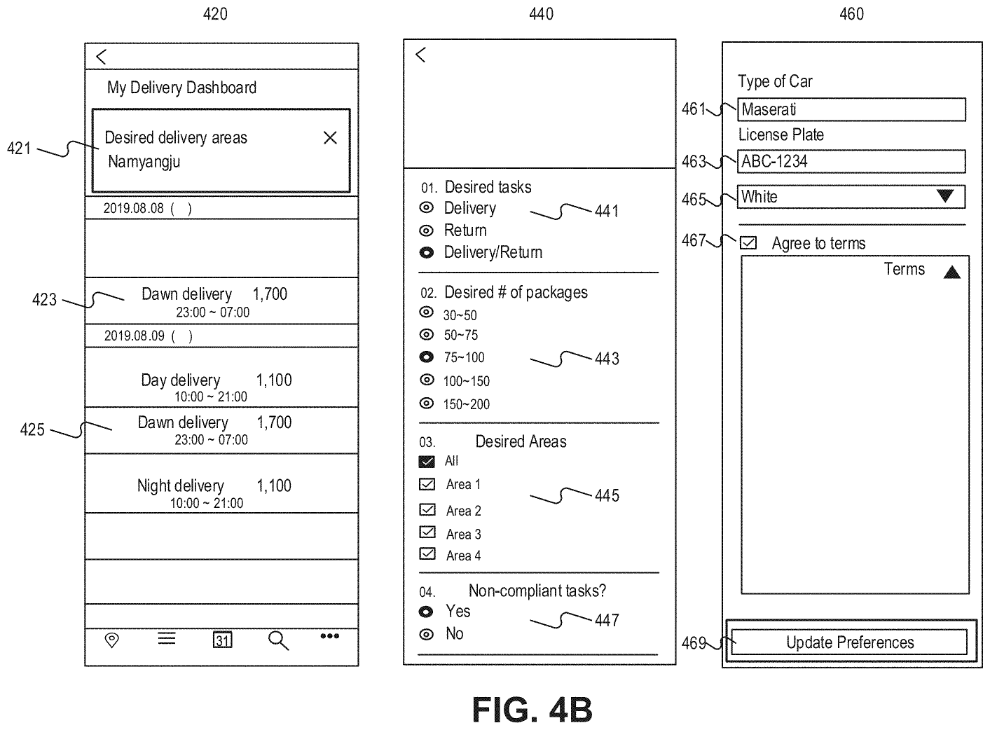

Transportation system 107, as described above, may be implemented as a computer system that enables communication between systems or devices in system 100 (such as internal front end system 105) and mobile devices 107A-107C. For example, as described below with respect to FIGS. 4A and 4B, a delivery worker (e.g., using mobile device 107A) may select preferences for delivery tasks, such as desired areas of a city, number of packages for delivery, and delivery times. As another example, as described below with respect to FIGS. 5A-5C, a delivery worker (e.g., using mobile device 107A) may request particular delivery tasks, accept the delivery tasks, and scan a visible indicia (such as a QR code) to determine that she is at the right location before beginning delivery.

Mobile devices 107A-107C may, in some embodiments, be configured to enable delivery workers to interface with one or more systems in system 100, such as transportation system 107, as described herein (including below with respect to FIGS. 4A, 4B, and 5A-5C). While FIG. 3 depicts mobile devices 107A-107C as mobile devices (e.g., cellular telephones, Personal Digital Assistants, tablets, phablets, or the like), in some embodiments, one or more of 107A-107C may be substituted with a different device, such as a desktop computer, a laptop computer, smart watches, smart glasses, a voice-enabled smart assistant, or any other device providing network connectivity and a user interface. Mobile devices 107A-107C may include a scanning device such as a camera for capturing a visual indicia (e.g., a two-dimensional barcode such as a QR code) or a circuit for capturing a non-visual indicia (e.g., a Near Field Communication (NFC) tag).

FIG. 4A depicts exemplary user interfaces 400, 402, and 404 for use by a delivery worker to request particular types of delivery tasks on a mobile device (107A-107C), consistent with the disclosed embodiments.

User interface 400 depicts a first interface displayed to a user on a mobile device such as mobile device 107A. Interface 400 includes a calendar 401, a button 403, a listing of jobs 405, a button 407, and a button 409. Calendar 401 enables a user to interact with mobile device 107A (e.g., by touching, clicking, dragging, or swiping) to view delivery tasks both in the future and in the past. A delivery worker may interact with one of the listed days to retrieve a list of delivery tasks, which will be displayed to the user in listing 405.

Button 403 enables a user to apply for one or more jobs complying with the delivery worker's preferences. An application for jobs is described below with respect to, for example, FIG. 4B.

Listing 405 lists the jobs that have been applied for by a delivery worker and that the delivery worker is approved to deliver. The first job in listing 405 is one example of such a listing; it includes the location (Namyangju), the type of delivery (same-day delivery), the time of day that the delivery worker must be available (10:00-17:00 on August 8), a time by which the delivery worker must cancel, if she is going to cancel the job (August 7), and a delivery fee that the deliver worker will receive in return for performing the deliver (1,100 won). In some embodiments, listing 405 may include more or fewer fields for each job that has been accepted by the delivery worker.

Interface 402 includes a map 411. Map 411, in some embodiments, may represent an area related to a delivery task accepted by the delivery worker. For example, the delivery task listed in interface 400 (in listing 405) may include particular area (such as a neighborhood, region, town, city, village, or other subdivision), depicted on map 411 as shaded to indicate that the delivery worker should expect that she may need to deliver one or more packages to customers in that area.

Interface 404 includes interface elements 413, 415, and 417. Each of interface elements 413, 415, and 417 allow a delivery worker to select times of day that she would like to accept particular types of delivery tasks. For example, a first delivery worker may want to accept delivery tasks for daytime delivery during the work week between 10:00 and 21:00, while only accepting overnight delivery tasks between 23:00 of one day and 07:00 of the next day

FIG. 4B depicts exemplary user interfaces 420, 440, and 460 for use by a delivery worker to accept particular delivery tasks on a mobile device, consistent with the disclosed embodiments. User interface 420 includes elements 421, 423, and 425.

Element 421 includes a listing of a delivery driver's desired delivery areas. In exemplary FIG. 4B, the delivery worker here has chosen to allow only deliveries in a particular city, Namyangju. The delivery worker can interact with element 421 to remove one or more desired delivery areas, or interact with element 421 to add additional delivery areas. While FIG. 4B depicts only a single desired delivery area—a single city—interface 420 enables a delivery worker to select larger or smaller numbers of areas, including subdivisions of a single city, town, or village (e.g., neighborhoods), as well as multiple cities, towns, or villages.

Element 423 depicts accepted and approved delivery tasks associated with a delivery worker. For example, the task depicted in element 423 is listed as a dawn delivery-type task (e.g., delivery before or close to dawn of a particular day). For this task, element 423 includes a delivery fee of 1,700 won per delivery and a requirement that the delivery be made between 11:00 of the night before the day listed (Aug. 8, 2019) and 07:00 of the day listed.

Element 423 lists additional delivery tasks accepted by and approved for the delivery worker. Each of these additional delivery tasks, associated with the next day, may have different parameters associated with them (e.g., a different delivery fee, a different delivery time, and a different delivery type).

Interface 440 depicts a preferences page for use by the delivery worker to select her preferences for delivery tasks. Exemplary interface 440 includes elements 441, 443, 445, and 447.

Element 441 relates to a delivery worker's chosen type of delivery tasks. For example, FIG. 4B depicts three kinds of delivery tasks: delivery (e.g., taking a package from a delivery site such as camp zone 215 and leaving it at a customer's residence), return (e.g., taking a package from a customer's residence and returning it to camp zone 215 or a return center), and delivery/return (e.g., taking one package from camp zone 215 to a customer's residence, and taking a second package from that residence or another residence to camp zone 215). (Other types of delivery tasks may be selected as well in some embodiments.) The delivery worker may interact with element 441 to select the type of delivery tasks she wishes to complete.

Element 443 depicts a selectable number of packages that the delivery worker wishes to deliver per job. A delivery worker may decide that a large number of packages is desirable because of the high delivery fee. In exemplary interface 440, element 443 requires selecting a range of packages; in some embodiments, element 443 may prompt delivery worker to select custom ranges (e.g., by inputting particular values), a minimum number of packages, or a maximum number of packages. Interface 440 may also prompt delivery worker to input a desired minimum delivery fee.

It must be noted that in some embodiments, the desired preferences in interface 440, including desired tasks, desired number of packages, and desired areas, may be overridden to ensure that the delivery worker receives at least some minimum number of delivery tasks for selection. Delivery worker may interact with element 447 to toggle a preference acceptability requirement to permit non-compliant tasks (i.e., non-preferred tasks that do not comply with one or more of the preferences in interface 440) to be received on mobile device 107A. For example, if a delivery worker selects “return” in element 441 and selects “yes” in element 447, and the only delivery tasks are “delivery” or “delivery/return” tasks, mobile device 107A may receive and display those available delivery tasks. If the delivery worker selected “no” in element 447, no delivery tasks would be displayed.

In some embodiments, the decision in element 447 may also be overridden to ensure that even those delivery workers who selected “no” in element 447 would still receive at least some minimum number of delivery tasks.

Interface 460 includes elements 461, 463, 465, 467, and button 469. Interface 460 enables a delivery worker to input information about a vehicle for use in carrying out assigned delivery tasks and to agree to terms and conditions. Element 461 enables a delivery worker to input the type of vehicle she will use to deliver packages. For example, the delivery worker may input a make and model of car by typing it in (e.g., using a keyboard or virtual keyboard) or selecting the make and model from a drop-down list. Element 463 enables a delivery worker to input a license plate. Element 465 enables a delivery worker to select a color.

In some embodiments, a delivery worker using mobile device 107A may input vehicle information to enable the delivery worker to enter a camp zone 215 (because, for example, otherwise-unauthorized individuals may be prevented from entering).

After entering or confirming information in elements 461, 463, 465, and 467, the delivery worker may interact with button 469 to update preferences for delivery tasks. In some embodiments, interacting with button 469 causes mobile device 107A to send a communication to transportation system 107 that includes changes to the delivery vehicle (elements 461, 463, 465) or changes to preferences (elements 441, 443, 445, 447).

FIG. 5A depicts an exemplary method 500 enabling configuration of preferences and job acceptance on a mobile device 107A, consistent with the disclosed embodiments. Exemplary method 500 is depicted as communication between mobile device 107A and transportation system 107; in some embodiments, one or more additional devices (e.g., internal front-end system 105 or a plurality of network devices) may separate the communication between mobile device 107A and transportation system 107.

Method 500 begins with step 501. In step 501, a delivery worker may initialize an application on mobile device 107A. For example, a delivery worker may click, drag, swipe, or otherwise interact with an icon on mobile device 107A to begin an application. In some embodiments, the application may operate as described above with respect to FIGS. 4A and 4B.

In step 503, delivery worker may use mobile device 107A to select one or more preferences for delivery tasks. Step 503 includes, for example, selection of areas for delivery, a number of packages, and time periods for delivery tasks. (Embodiments of step 503 have been described above with respect to FIGS. 4A and 4B.)

In step 505, mobile device 107A may forward the selected preferences to transportation system 107, which receives them in step 507.

In step 509, transportation system 107 may receive a list of available delivery tasks. In some embodiments, transportation system 107 may retrieve a list of available delivery tasks from internal front end system 105, which may retrieve the delivery tasks from one or more systems in system 100 (e.g., shipment and order tracking system 111 or shipment authority technology system 101). Transportation system 107 may receive the list of tasks in a variety of formats, including as a flat file, a database, a SQL query result, a comma-separated value (CSV) file, a Microsoft Excel file, or the like.

In step 511, transportation system 107 may filter the received delivery tasks based on preferences associated with mobile device 107A. For example, delivery tasks may be represented using a data store comprising a plurality of fields, such as neighborhood, start time/date, type of work, or the like. (Exemplary data formats are described below with respect to FIGS. 6A and 6B.) In some embodiments, transportation system 107 may filter the received tasks based on the preferences received in step 507. For example, if a delivery worker had checked “yes” on element 447 (FIG. 4B), indicating that he would like to receive non-preferred tasks, transportation system 107 may forward all or a subset of tasks received in step 509 (e.g., only those tasks in the same city, despite any preferences for a number of packages or a selection of neighborhoods). In other embodiments, transportation system 107 may sort the received tasks based on the preferences received in step 507. For example, if a delivery worker had checked “yes” on element 447 (FIG. 4B), indicating that he would like to receive non-preferred tasks, transportation system 107 may determine preferred tasks from those tasks received in step 509 (e.g., those that comply with each preference), and may sort a list of tasks to place those preferred tasks first (before forwarding as discussed below with respect to step 513).

In step 513, transportation system 107 forward may the filtered and/or sorted tasks to mobile device 107A, which are received in step 515. The forwarded tasks may include task information such as a task ID, a time, a location for the task, a number of packages, a delivery fee, or other information.

In some embodiments, the tasks received by mobile device 107A may only include those tasks that are compliant with the delivery worker's preferences (as discussed above with respect to FIGS. 4A and 4B). In other embodiments the received tasks may include a sorted list of tasks, where the tasks compliant with the delivery worker's preferences are separated from the tasks that are not compliant (e.g., the compliant tasks are first in the list while the non-compliant tasks are listed after).

In step 517, mobile device 107A may present the received tasks to on a display for viewing by the delivery worker. In some embodiments, as discussed above, the tasks may include only those tasks that are compliant with the delivery worker's preferences. In other embodiments the tasks may include all tasks, but order the tasks that are not compliant with the delivery worker's preferences towards the bottom of a displayed list or in a separate list. As discussed above with respect to FIG. 4B the information displayed for each task may include information such as a task ID, a time, a location for the task, a number of packages, a delivery fee, or other information.

In step 519, mobile device 107A may receive one or more selections (e.g., interactions such as a swipe, a click, a tap, or a drag) from the delivery worker on at least one task. For example, a delivery worker may click a checkbox button to accept a task and may click an “X” button to decline a task. In other embodiments, a delivery worker may only be given the option to click a checkbox button to accept tasks. Mobile device 107A may gather the tasks that are accepted by the delivery worker (e.g., by a task ID) and forward those to transportation system 107. The selected tasks are received by transportation system 107 in step 523.

In step 525, transportation system 107 may determine whether or not to approve a received accepted task. Step 525 may be performed in a variety of ways. As one example, some embodiments include approving a received accepted task may comprise forwarding a notification to a computing device associated with a user, such as a mobile device operated by an administrator for a camp zone 215. The administrator may determine whether or not to approve the delivery worker's acceptance by interacting with a user interface element. In other embodiments, approving a received accepted task may comprise performing an automated approval process. Such a process may include, for example, approving a delivery worker based on the delivery worker's past history of deliveries (e.g., approving accepted jobs for a reliable delivery worker and declining accepted jobs for an unreliable delivery worker).

As part of step 525, a task may be removed from a queue of available tasks. This prevents, for example, a first user on one mobile device 107A from accepting the task substantially simultaneously with a second user on a mobile device 107C before an administrator or other user can approve or decline the acceptance by the delivery worker using mobile device 107A.

If in step 525 the transportation system 107 determines that the task acceptance should be approved (e.g., based on user input or the result of a determination), the method may proceed to step 529, where transportation system 107 forwards an approval message to mobile device 107A. The approval message may include a task ID or other information associated with the task. In some embodiments (including those discussed below with respect to FIG. 5B) the approval message may include a camp code associated with camp zone 215. The camp code may be, for example, a unique static or dynamic identifier associated with camp zone 215 (such as “CAMP #1” or “CAMP XYZ123”). The approval message is received at mobile device 107A in step 531.

If, on the other hand, it is determined in step 525 that the task acceptance should be approved (e.g., based on user input or the result of a determination), the method may proceed to step 527. In step 527, transportation system 107 may insert the task into a queue of available tasks to ensure that another user (e.g., a delivery worker using mobile device 107C) is able to accept the task. In some embodiments, step 527 also includes sending a declination message to mobile device 107A. The declination message may include a task ID or other information associated with the task.

FIG. 5B depicts an exemplary method 540 for presence confirmation on a mobile device, consistent with the disclosed embodiments.

Method 540 begins at step 541. In step 541, a delivery worker may initialize an application on mobile device 107A. For example, a delivery worker may click, drag, swipe, or otherwise interact with an icon on mobile device 107A to begin an application.

In step 543, mobile device 107A may prompt the user (e.g., a delivery worker) to scan an indicia at a camp zone (e.g., camp zone 215) to retrieve a camp code. Embodiments of the present disclosure utilize a Quick Response (QR) code as an example of such an indicia, but other embodiments are possible as well. For example, mobile device 107A may be configured to scan other visual indicia (including one- and two-dimensional bar codes) or non-visual indicia (including NFC tags) to retrieve the camp code. In some embodiments, mobile device 107A may be configured to enable camp code entry (e.g., via a virtual keyboard).

In step 545, mobile device 107A may compare the scanned camp code to approval messages received from transportation system 107 in FIG. 5A. For example, the scanned camp code may include an identifier such as “CAMP #1” and mobile device may contain approval messages having camp codes of “CAMP #3,” “CAMP #4,” “CAMP #1,” and “CAMP #3.” In this situation, the delivery worker using mobile device 107A may have four delivery tasks assigned to her—two of which are at Camp #3. While in some embodiments, step 545 comprises comparing camp codes in approval messages stored on mobile device 107A, other embodiments may comprise comparing camp codes in approval messages stored elsewhere (e.g., in transportation system 107 or another system).

In step 547, mobile device 107A may determine where there is a match between a stored approval and the code scanned in step 543. If there is no match between any stored approval and the code scanned in step 543, method 540 may proceed to step 549. In step 549, mobile device 107A may provide a warning to the delivery worker indicating that the camp is not associated with any accepted and approved delivery tasks associated with the delivery worker. The warning may include a message that the delivery worker should proceed to another camp.

If, on the other hand, there is a match between a stored approval and the code scanned in step 543, method 540 may proceed to step 553. In step 553, mobile device 107A may provide a notice to the delivery worker that the delivery worker is in the correct location. The message may include directions for how to pick up a first package for delivery.

If, on the other hand, there is a match between a stored approval and the code scanned in step 543, but the code has already been scanned (for example, because the user has already delivered all approved tasks at that camp or accidentally scans the code at camp zone 215 twice), method 540 may proceed to step 551. In step 551, mobile device 107A may provide a warning to the delivery worker that the code has already been scanned. The warning may include a message that the delivery worker should continue with delivery or proceed to another camp.

FIG. 5C depicts exemplary user interfaces 550, 552, and 554 for presence confirmation on a mobile device, consistent with the disclosed embodiments.

Interface 550 corresponds to step 553 (FIG. 5B), and includes an indication that the delivery worker is in the correct location. Other information may be displayed on interface 550, including directions for how to pick up a first package for delivery.

Interface 552 corresponds to step 551 (FIG. 5B), and includes an indication that the delivery worker has already scanned the camp code at camp zone 215 with mobile device 107A. Other information may be displayed on interface 550, including a message that the delivery worker should continue with delivery or proceed to another camp.

Interface 554 corresponds to step 549 (FIG. 5B), and includes an indication that there is no match between any stored approval and the code scanned by mobile device 107A. Other information may be displayed on interface 550, including a message that the delivery worker should proceed to another camp or contact a camp administrator for assistance.

FIG. 6A depicts an exemplary data structure 600 for instantiating delivery tasks for distribution to delivery workers on a mobile device, consistent with the disclosed embodiments. As mentioned above with respect to FIGS. 3 and 5A, a user (e.g., a camp administrator associated with camp zone 215) may enter data corresponding to delivery tasks. Data structure 600 may be implemented as a database, a data store, a flat file, a comma-separated value (CSV) file, a Microsoft Excel (XLS) file, a table, a SQL database, or any other form of data structure that stores information. In some embodiments, a user (e.g., a camp administrator associated with camp zone 215) may upload the data structure to a system in FIG. 1A (e.g., transportation system 107) to indicate which types of work are forecasted to be needed over a coming time period (e.g., the following 48 hours). In other embodiments, data structure 600 may be generated automatically by another system in FIG. 1A (e.g., SAT system 101).

Data structure 600 may include, for example, camp identifier 601, delivery date 603, delivery type 605, worker type 607, task title 609, acceptance window 611, task window 613, and number of workers 615.

Camp identifier 601, in some embodiments, may represent an identifier associated with a camp zone 215 from which a particular delivery task originates. The identifier may be alphanumeric, numeric, or alphabetic, may include symbols, or may be represented using any other form of data.

Delivery date 603, in some embodiments, may indicate a date on which the delivery task is associated. For example, delivery date 603 may represent the day on which all of the packages for a delivery task must be picked up or must be delivered by.

Delivery type 605, in some embodiments, may indicate a type of delivery for the delivery task. Examples of delivery types include dawn delivery (e.g., delivery before or close to dawn of a particular day), same-day delivery (e.g., delivery by the end of a day if ordered by a cutoff time), next-day delivery (e.g., delivery by the end of a next day if ordered by a cutoff time), and overnight delivery (e.g., delivery in the evening of one day or early morning of a next day). Other delivery types are possible as well.

Worker type 607, in some embodiments, may indicate a type of worker that should be assigned to the delivery task. Examples of worker types include a “flex” or temporary worker (e.g., who works as an independent contractor and uses the systems described above to select, accept, and deliver packages) and a full-time worker (e.g., who works for the company that owns or operates camp zone 215 and is assigned tasks as part of a daily routine).

Task title 609, in some embodiments, may represent a title assigned to the task. Task title 609 may be used to aid in differentiating between tasks.

Acceptance window 611, in some embodiments, may indicate a time period during which a delivery worker must accept an offered delivery task. If the delivery worker uses mobile device 107A to accept the delivery task outside of window 611, the worker's request may be declined (automatically or otherwise).

Task window 613, in some embodiments, may indicate a time period during which a delivery worker that has accepted (and whose acceptance has been approved) must deliver the packages associated with the delivery task. In some embodiments, task window 613 may be used to ensure compliance and rate or grade delivery workers based on their timeliness.

Number of workers 615, in some embodiments, may indicate a number of workers that are thought to be necessary for a particular delivery task. For example, task 617 requires 45 delivery workers to deliver the associated packages, while task 619 requires 27 delivery workers to deliver its associated packages. Number of workers 615 may be estimated by a formula or manually entered by a user.

FIG. 6B depicts an exemplary user interface 620 for data entry relating to a delivery task for distribution to delivery workers on a mobile device, consistent with the disclosed embodiments.

User interface 620 includes elements 621, 623, 625, 627, 629, 630, 631, 632, 633, 635, 637, and 639. A user (e.g., an administrator of camp zone 215) may enter data into the elements on user interface 620 to create a new delivery task for acceptance by one or more delivery workers. In some embodiments, transportation system 107 may generate pre-populated information for one or more elements of user interface 620, before presentation to a user.

Element 621, in some embodiments, may enable a user to enter a title associated with the delivery task. The title may be used to aid in differentiating between tasks.

Element 623, in some embodiments, may enable a user to select a camp associated with a delivery task. In some embodiments, element 623 may be a drop-down box, while in other embodiments element 623 may be a text field for entry (e.g., via a keyboard).

Element 625, in some embodiments, may enable a user to select whether the camp is a mobile camp. A mobile camp, in some embodiments, may be a camp zone 215 that is not owned or operated by a company that owns or operates other systems in FIG. 1A or other zones in FIG. 2. Such a mobile camp may be at, for example, a gas station, a truck, a flatbed, or a rented warehouse; other possibilities are envisioned as well.

Element 627, in some embodiments, may enable a user to input a delivery type. Examples of delivery types include dawn delivery (e.g., delivery before or close to dawn of a particular day), same-day delivery (e.g., delivery by the end of a day if ordered by a cutoff time), next-day delivery (e.g., delivery by the end of a next day if ordered by a cutoff time), and overnight delivery (e.g., delivery in the evening of one day or early morning of a next day). Other delivery types are possible as well.

Element 629, in some embodiments, may enable a user to input an acceptance window which may indicate a time period during which a delivery worker must accept an offered delivery task. If the delivery worker uses mobile device 107A to accept the delivery task outside of that acceptance window, the worker's request may be declined (automatically or otherwise).

Element 630, in some embodiments, may enable a user to input a number of packages for the delivery task. The number of packages may be an estimate and may be pre-populated based on historical data (e.g., a range of packages for delivery to a particular neighborhood during the previous 7 days).

Element 631, in some embodiments, may enable a user to input a task window which may indicate a time period during which a delivery worker that has accepted (and whose acceptance has been approved) must deliver the packages associated with the delivery task. In some embodiments, the task window may be used to ensure compliance and rate or grade delivery workers based on their timeliness.

Element 632, in some embodiments, may enable a user to input a delivery area for the delivery task. In some embodiments, the delivery region may comprise a neighborhood, a street, an apartment complex or another geographical or political subdivision.

Element 633, in some embodiments, may enable a user to input a number of workers for the delivery task. In some embodiments, the number of workers may indicate a number of workers that are thought to be necessary for a particular delivery task. The number of workers may be estimated by a formula (e.g., based on a number of packages or the size of the area) or manually entered by a user.

Element 635, in some embodiments, may enable a user to insert a delivery fee per package. Transportation system 107 may provide the delivery fee to a delivery worker via mobile device 107A to enable the delivery worker to decide whether or not to accept the delivery task.

Element 637 in some embodiments, may enable a user to insert a return fee per package. Return fee may represent an amount received by the delivery worker for each package returned from a customer (e.g., to camp zone 215). Like the delivery fee in element 635, transportation system 107 may provide the return fee to a delivery worker via mobile device 107A to enable the delivery worker to decide whether or not to accept the task.

Element 639, in some embodiments, may enable a user to submit the information on user interface 620. Interacting with element 639 (which may be, for example, a user interface button) may cause a system (e.g., a mobile device) to send a communication to transportation system 107 that includes a request to create a new delivery task for acceptance by a delivery worker.

Note that FIGS. 6A and 6B both relate to inputting tasks for acceptance by delivery workers, and that each of FIGS. 6A and 6B include different fields for data entry. In some embodiments, tasks entered using data structure 600 of FIG. 6A may require additional information not required if entered using user interface 620 of FIG. 6B. In other embodiments, tasks entered using data structure 600 may require identical information as those entered using user interface 620, and additional/modified elements or data fields may be required for entry.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for task acceptance, implemented on a mobile device comprising:
a display device;
a scanning device;
a memory storing instructions; and
at least one processor configured to execute the instructions to:
display a first graphical user interface on the display device when a user initiates an application, the first graphical user interface comprising an interactive calendar and a first button;
in response to a selection of the first button, display a second graphical user interface on the display device, the second graphical user interface displaying a plurality of selectable interface elements associated with delivery preferences, the selectable interface elements being configured to transmit delivery preferences to a server upon selection, the selectable interface elements comprising at least one of neighborhood preference, task preference, or number of packages preference;
receive, from the server, a filtered list of delivery tasks comprising tasks that comply with transmitted delivery preferences, the filtered list of delivery tasks being a portion of available delivery tasks received from an internal front end system;
after receiving the filtered list, generating a third graphical user interface on the display device, the third graphical user interface displaying a delivery dashboard comprising a plurality of interactive icons representing the filtered list of delivery tasks, the interactive icons being sorted based on the delivery preferences;
receive, on the display device, an interaction with at least one of the interactive icons;
responsive to receiving the interaction, forward a task identifier associated with the accepted task to the server and receive a message in response including a code associated with a first delivery site of a distribution center for accomplishing the accepted delivery task;
display a fourth graphical user interface on the display device when receiving an interaction indicating presence at the first delivery site, the fourth graphical user interface displaying scanning instructions;
scan, via the scanning device, an indicia associated with the first delivery site of the distribution center, and determine whether the indicia matches the received code; and
responsive to a determination that the indicia matches the received code, provide an indication that the accepted delivery task is performed at the first delivery site.

2. The computer-implemented system of claim 1, wherein the scanning device captures images.

3. The computer-implemented system of claim 2, wherein the scanned indicia is a two-dimensional barcode.

4. The computer-implemented system of claim 1, wherein the indicia is compared to a copy of the received code stored on the mobile device.

5. The computer-implemented system of claim 1, wherein the plurality of selectable interface elements further comprise a preference acceptability requirement.

6. The computer-implemented system of claim 5, wherein:
the preference acceptability requirement is set to only accept tasks complying with the preferences; and
the filtered list comprises delivery tasks that strictly comply with the preferred delivery type per task, the preferred number of packages per task, and the preferred delivery areas per task.

7. The computer-implemented system of claim 5, wherein:
the preference acceptability requirement is set to accept tasks other than those complying with the preferences; and
the filtered list comprises delivery tasks that comply with at least one of the preferred delivery type per task, the preferred number of packages per task, or the preferred delivery areas per task.

8. (canceled)

9. A computer system for task acceptance comprising:
a memory storing instructions; and
at least one processor configured to execute the instructions to:
receive, from an internal front end system, a list of delivery tasks for acceptance, each delivery task being associated with a delivery site of a distribution center;
transmit, to a mobile device, instructions to generate a first graphical user interface, the first graphical user interface displaying a plurality of selectable interface elements associated with delivery preferences, the selectable interface elements being configured to transmit delivery preferences to the at least one processor upon selection, the selectable interface elements comprising at least one of neighborhood preference, task preference, or number of packages preference;
receive, from the mobile device, delivery preferences in response to the selection of the plurality of interface elements;
generate a filtered list of delivery tasks by filtering the list of delivery tasks according to the delivery preferences, the filtered list being a portion of the list of delivery tasks;
transmit, to the mobile device, instructions to generate a second graphical user interface, the second graphical user interface displaying a delivery dashboard comprising a plurality of interactive icons representing the filtered list, the interactive icons being sorted based on the delivery preferences;
receive, from the mobile device upon selection of one or more of the plurality of interactive icons, a request for one or more of the delivery tasks for a delivery worker;
determine whether to approve the request; and
responsive to determining to approve the request, transmit, to the mobile device, instructions to generate a third graphical user interface, the third graphical user interface comprising a message box displaying scanning instructions.

10. The computer-implemented system of claim 9, wherein:
the selectable interface elements comprises a preference acceptability requirement; and
generating the filtered list comprises filtering the list of delivery tasks to remove tasks that do not strictly comply with the preferences when receiving a selection of the preference acceptability requirement.

11. The computer-implemented system of claim 9, wherein:
the selectable interface elements comprises a preference acceptability requirement; and
generating the filtered list comprises:
determining that the preference acceptability requirement is set to only accept tasks other than those complying with the preferences; and
filtering the list of delivery tasks to include tasks that comply with at least one of the preferences.

12. The computer-implemented system of claim 9, wherein determine whether to approve the received acceptance comprises receiving an indication from a second system approving or declining the received acceptance.

13. The computer-implemented system of claim 9, wherein determine whether to approve the received acceptance comprises determining whether to approve the received acceptance based on delivery history associated with the delivery worker.

14. The computer-implemented system of claim 9, wherein receiving the list of delivery tasks comprises:
preparing a user interface comprising at least one element for entering information associated with the delivery tasks;
forwarding the user interface to a computer system operated by an administrator associated with the delivery site; and
receiving, through the user interface, the information associated with the delivery tasks.

15. The computer-implemented system of claim 9, wherein receiving a list of delivery tasks comprises:
receiving a data structure formatted to include information associated with forecasted delivery tasks; and
retrieve the information associated with the forecasted delivery tasks.

16. The computer-implemented system of claim 9, wherein the list of delivery tasks comprises at least one of a delivery task, a return tasks, or a delivery/return task.

17. The computer-implemented system of claim 9, wherein each task of the list of delivery tasks comprises an acceptance window.

18. The computer-implemented system of claim 17, wherein determining whether to approve the received acceptance comprises:
determining a current time;
comparing the current time to the acceptance window;
approving the received acceptance if the current time is inside of the acceptance window; and
declining the received acceptance otherwise.

19. The computer-implemented system of claim 9, wherein:
receiving an acceptance of a task further comprises removing the task from the list of delivery tasks;
based on determining to reject the received acceptance:
forwarding a rejection message to the mobile device;
adding the task to the list of delivery tasks.

20. A computer-implemented system for task acceptance comprising a mobile device and a computing device interconnected via a network, the mobile device comprising:
a display device;
a scanning device;
a memory storing instructions; and
at least one processor configured to execute the instructions to:
display a first graphical user interface on the display device when a user initiates an application, the first graphical user interface comprising an interactive calendar and a first button;
in response to a selection of the first button, display a second graphical user interface on the display device, the second graphical user interface displaying a plurality of selectable interface elements associated with delivery preferences, the selectable interface elements being configured to transmit delivery preferences to a server upon selection, the selectable interface elements comprising at least one of neighborhood preference, task preference, or number of packages preference;
receive, from the computing device, a filtered list of delivery tasks comprising tasks that comply with transmitted delivery preferences, the filtered list of delivery tasks being a portion of available delivery tasks received from an internal front end system;
after receiving the filtered list, generating a third graphical user interface on the display device, the third graphical user interface displaying a delivery dashboard comprising a plurality of interactive icons representing the filtered list of delivery tasks, the interactive icons being sorted based on the delivery preferences;
receive, on the display device, an interaction with at least one of the interactive icons;
responsive to receiving the interaction, forward a task identifier associated with the accepted task to the server and receive a message in response including a code associated with a first delivery site of a distribution center for accomplishing the accepted delivery task; receive, on the display device, an interaction to confirm presence at the first delivery site;
display a fourth graphical user interface on the displaying device when receiving an interaction indicating presence at the first delivery site, the fourth graphical user interface comprising a message box displaying scanning instructions;
scanning, via the scanning device, an indicia associated with the first delivery site of the distribution enter, and determine whether the indicia matches the received code; and
responsive to a determination that the indicia matches the received code, provide an indication that the accepted delivery task is performed at the first delivery site.
